(19) United States
(12) Patent Application Publication
(10) Pub. No.: US 2006/0042745 A1
(43) Pub. Date: Mar. 2, 2006

(54) Ionization method of surface of high molecular materials

(76) Inventors: Eulmun Kim, Kyunggi=do (KR); Deoggu Lim, Kyunggi-do (KR)

Correspondence Address: PARK LAW FIRM, 3255 WILSHIRE BLVD, SUITE 1110, LOS ANGELES, CA, 90010, US

(21) Appl. No.: 10/522,369

(22) PCT Filed: Aug. 18, 2003
(86) PCT No.: PCT/KR03/01659

§ 371 Date: Jan. 25, 2005

(30) Foreign Application Priority Data
May 9, 2003 (KR) 10-2003-0029393

(51) Int. Cl. B29D 31/00

(52) U.S. Cl. 156/242

(57) ABSTRACT

Disclosed is a method of ionizing surfaces of polymer-molded goods to intercept electromagnetic waves passing therethrough and to prevent the polymer-molded goods from being electrically charged. The method includes maintaining a main chamber and pre-chambers located before and after the main chamber under pressure of 10⁵ torr using a vacuum pump, holding objective products by a spring holder on a carrier of an inlet chamber, transferring the objective products through a preheating chamber and the first pre-chamber into the main chamber, generating plasma by heating of a filament or arc generation of an ionization gun while controlling an ion beam current of electric power supplied to an ion generating gun, adding helium, argon, or nitrogen into the plasma to yield gas cations, irradiating the gas cations to the objective products, and discharging the resulting ionized products through the pre-chamber and an outlet chamber.

### TECHNICAL FIELD

The present invention pertains to a method of ionizing surfaces of polymer-molded goods. More particularly, the present invention relates to a method of ionizing surfaces of polymer-molded goods, in which gas cations are irradiated to the polymer-molded goods to improve a surface hardness of the polymer-molded goods, to prevent the surfaces of the polymer-molded goods from being electrically charged, and to intercept electromagnetic waves passing through the polymer-molded goods. Therefore, users are shielded from various harmful electromagnetic waves and microwaves radiated from inner electronic circuit devices of electric and electronic products including cases made of the polymer-molded goods, and injurious static electricity occurring at nonconductors constituting the electric and electronic products. Furthermore, when the polymer-molded goods ionized at the surfaces thereof according to the present invention are applied to the electric and electronic products, the electric and electronic products then have a prolonged life span, and reuse of the used polymer-molded goods is preferably increased to reduce pollution.

### BACKGROUND ART

As well known to those skilled in the art, polymer-molded goods are coated with a conductive coating substance, or mixed with an additive or a filler to form a case applied to a portable electronic terminal, such as a mobile phone, PDA (personal digital assistants), and a notebook computer. In this regard, the conductive coating substance coated on inner and outer surfaces of the case made of a polymer material functions to intercept harmful electromagnetic waves radiated through electronic circuit devices of the portable electronic terminal and to provide electric conductivity to the case of the portable electronic terminal.

The mobile phones are coated with a conductive paint containing silver powder at inner and outer surfaces thereof in a thickness of 0.1 mm or less so as to intercept the electromagnetic waves radiated from electronic parts constituting the mobile phones or to prevent static electricity from occurring at nonconductor parts of the mobile phones.

Conventionally, silver powder, carbon particles, carbon fibers, or metal materials acting as the additive are mixed with a polymer resin in order to provide conductivity to the polymer resin. However, the polymer resin containing the filler such as carbon particles and carbon fibers has not a desired intrinsic resistance value of 10 Ω/cm² or lower. Further, when metal powder such as the silver powder is added into the polymer resin, films are formed on surfaces of products made of the polymer resin. Accordingly, the products are made with a poor appearance. Furthermore, because the silver powder acting as the filler is usually added into the polymer resin in an amount of 60% or higher, use of the silver powder as the filler is not preferable in terms of weights, qualities, and production costs of the end products.

Generally, it is very difficult to reuse the products treated according to an electromagnetic wave interruption process using the above metal powder, which leads to pollution and a waste of resources.

Particularly, the conductive coating of the polymer resin using the silver powder or carbon physically, chemically affect the products made of the polymer resin to weaken the durability of the products. Hence, the surfaces of the products are easily discolored, scratched, and abraded, leading to reduced life spans for the products. As well, conventionally, there is a difficulty in intercepting the electromagnetic waves radiated through display parts, made of non-conductive materials, constituting the portable electronic terminal, or preventing the display parts from being electrically charged. The interception of the electromagnetic waves and the prevention of the electric charge are important factors in producing LCD and CRT.

Meanwhile, in the case of a conductive coating process of the polymer-molded goods, a desired coating effect is not secured if the surfaces of the products are not coated with the conductive coating substance in a uniform thickness. Accordingly, there is a need to apply a complicated, sophisticated technology and device to the conductive coating process of the products so as to ensure the desired coating effect. At this time, use of the complicated, sophisticated technology and device contributes to increasing development costs regarding the conductive coating process, thereby production costs are increased.

Additionally, when the surfaces of the polymer-molded goods are coated with the conductive coating substance, a predetermined level of interception index (for example, 20% interception index) must be secured so as to desirably intercept the electromagnetic waves and to stably operate inner circuit parts. However, it is very difficult to reach the desired level of an interception index.

Furthermore, it is difficult to reduce the production costs of the polymer formed goods coated with the conductive coating substance because the conductive coating substance added into the polymer formed goods is high-priced and a reuse index of the polymer formed goods coated with the conductive coating substance is relatively low, and makers must catch the flak from users because the electromagnetic waves radiated from the end products are undesirably intercepted and the electric charge of the end products is insufficiently prevented.

### DISCLOSURE OF THE INVENTION

Accordingly, the present invention has been made keeping in mind the above problems occurring in the prior art, and an object of the present invention is to provide a method of ionizing surfaces of polymer-molded goods, onto which optimum surface electric conductivity is uniformly provided, thereby the ionized polymer-molded goods are practically applied to a desired electronic telecommunication device to effectively intercept electromagnetic waves radiated from the electronic telecommunication device such as a portable electronic terminal and to enable an inner circuit of the electronic telecommunication device to be stably operated.

It is another object of the present invention is to provide a method of ionizing surfaces of polymer-molded goods, in which the polymer-molded goods are largely improved in terms of surface hardness, and the surfaces of the polymer-molded goods are finely deformed to minimize surface discoloration, defects, and abrasion of end products without a separate coating process, thereby preventing the surfaces of the polymer-molded goods from being electrically charged and intercepting electromagnetic waves radiated through the surfaces of the polymer-molded goods.

It is a further object of the present invention to provide a method of ionizing surfaces of polymer-molded goods so as to prevent the surfaces of various displays including CRT from being electrically charged and to intercept electromagnetic waves radiated through the surfaces of the displays, in which a resistance value against a surface electric conductivity of each display is uniformly distributed on the entire surface of the display to protect a user's eyesight.

It is still another object of the present invention to provide a method of ionizing surfaces of polymer-molded goods, in which desired surface electric conductivity is provided to the surfaces of the polymer-molded goods without a separate additive or filler to enable IC packages or LCDs to be stably carried, and a reuse index of the ionized polymer-molded goods is improved to prevent pollution and a waste of resources.

It is yet another object of the present invention to provide a method of ionizing surfaces of polymer-molded goods, in which no high-priced additive is added to the polymer-molded goods and a complicated coating process are omitted, thereby reducing costs of the ionization of the polymer-molded goods and minimizing a defective proportion of the polymer-molded goods.

Additional objects and/or advantages of the invention will be set forth in part in the description which follows and, in part, will be obvious from the description, or may be learned by practice of the invention.

The above and/or other objects are achieved by providing a method of ionizing surfaces of polymer-molded goods to intercept electromagnetic waves passing therethrough, including a first step of maintaining a main chamber and first and second pre-chambers located before and after the main chamber, which constitute a vacuum unit, under reduced pressure of 10⁵ torr using a vacuum pump, a second step of holding objective products, to be irradiated by ions, by a spring holder positioned on a carrier of an inlet chamber, and transferring the objective products held in the spring holder through a preheating chamber and the first pre-chamber into the main chamber, a third step of generating plasma by heating of a filament or arc generation of an ionization gun while controlling an ion beam current of electric power supplied to an ion generating gun in the main chamber to a predetermined level, adding helium gas, nitrogen gas, or argon gas into the plasma to yield gas cations, and irradiating the gas cations to the objective products, and a fourth step of moving the resulting ionized products from the main chamber to the second pre-chamber using the carrier, and then discharging the resulting ionized products through an outlet chamber.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph showing electric properties of a product of which a surface is ionized according to the present invention;

FIG. 2 is a graph showing surface hardness as a function of an ion irradiation depth for the product of which the surface is ionized according to the present invention; and

FIG. 3 is a graph showing a production amount of the ionized product in conformity to an ion irradiation time when the product is ionized while an ion beam current is properly controlled.

### BEST MODE FOR CARRYING OUT THE INVENTION

Reference should now be made to the drawings, in which the same reference numerals are used throughout the different drawings to designate the same or similar components.

An ionization system provided with a vacuum unit, a carrier, and an ion generating gun is used to ionize surfaces of polymer-molded goods to increase surface hardness of the polymer-molded goods, to prevent the polymer-molded goods from being electrically charged, and to intercept electromagnetic waves radiated through the polymer-molded goods.

The vacuum unit has a series of chamber line composed of a plurality of chambers, which consists of a carrier inlet chamber, a preheating chamber for removing moisture, an auxiliary pre-chamber, a main chamber for irradiating ions to an objective body, a pre-chamber, and an outlet chamber sequentially disposed. In this regard, the movement of the polymer-molded goods between the chambers is conducted by the carrier.

Additionally, the vacuum unit further includes PLC-control based pumps, auto valves, sensors, and gates in addition to the chambers.

The main chamber, and the pre-chambers located before and after the main chamber are constantly maintained under reduced pressure of 10⁵ torr to prevent the workability of the surface ionization of the polymer-molded goods from being reduced due to a pressure difference between the chambers.

The carrier is provided with a spring holder used to buff, fix, move, and revolve the polymer-molded goods, and an exterior motor. At this time, the movement of the carrier is properly controlled in an ion irradiation direction by an electric field and a magnetic field, and ions are uniformly irradiated to the entire polymer-molded goods by the spring holder and exterior motor, thereby the polymer-molded goods are stably moved between the chambers.

In the ion generating gun installed in the main chamber of the vacuum unit, when a plasma is formed by arc or a filament heated by a supplied electric power with an ion beam current of 0 to 100 mA, an atmospheric gas such as helium, nitrogen, or argon is added into the plasma to generate gas cations, and the resulting gas cations are irradiated in a predetermined density for a predetermined time to portable electronic terminal formed by injection-molding a polymer material in the main chamber, thereby a surface of the portable electronic terminal is ionized.

Hereinafter, a detailed description will be given of the ionization of the surfaces of the polymer-molded goods applied to the portable electronic terminal and the like using the above ionization system.

The main chamber, and the pre-chambers located before and after the main chamber constituting the vacuum unit are maintained under reduced pressure of 10⁵ torr using the vacuum pump in the first step.

In the second step, objective body, to be irradiated by ions, for example the portable electronic terminal, is held by the spring holder positioned on the carrier of the inlet chamber, and then transferred through the preheating chamber and pre-chamber to the main chamber.

The ion beam current of the electric power supplied to the ion generating gun in the main chamber is properly controlled to heat the filament or to generate the arc to generate the plasma in the third step. Helium, nitrogen, or argon gas is then added into the plasma to yield gas cations. The resulting cations are irradiated to the polymer-molded goods. At this time, an ion irradiation time and an ion density depend on heat tolerance of the polymer material, and surface hardness and electric conductivity of end products, and the cations are uniformly irradiated to the entire polymer-molded goods by the motor of the carrier.

The polymer-molded goods ionized in the main chamber are then moved by the carrier to the pre-chamber, and discharged through the outlet chamber, thereby accomplishing the ionization of the surfaces of the polymer-molded goods in the fourth step.

A better understanding of the present invention may be obtained in light of the following examples which are set forth to illustrate, but are not to be construed to limit the present invention.

### EXAMPLE 1

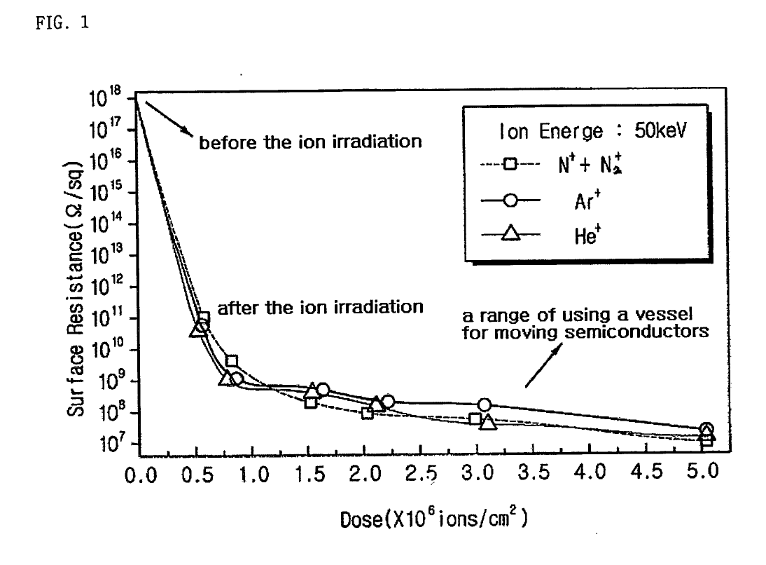

It was confirmed that desired surface resistance values were obtained using N+N, Ar, and He at an ion energy level of 50 kev by an ion beam radiated from an ion generating gun. Required surface electric conductivities of a portable electronic terminal were 10⁴ to 10⁵ Ω/cm², and 10⁸ to 10¹⁰ Ω/cm² for inner and outer surfaces of the portable electronic terminal, respectively. Thus, when ions were irradiated to a surface of the portable electronic terminal in a dose of 0.5×10¹⁶ to 1.8×10¹⁶ ions/cm² using N, surface electric conductivity of the portable electronic terminal was 10⁶ to 10¹² Ω/cm² according to an irradiation time of the ions, and the results were shown in FIG. 1.

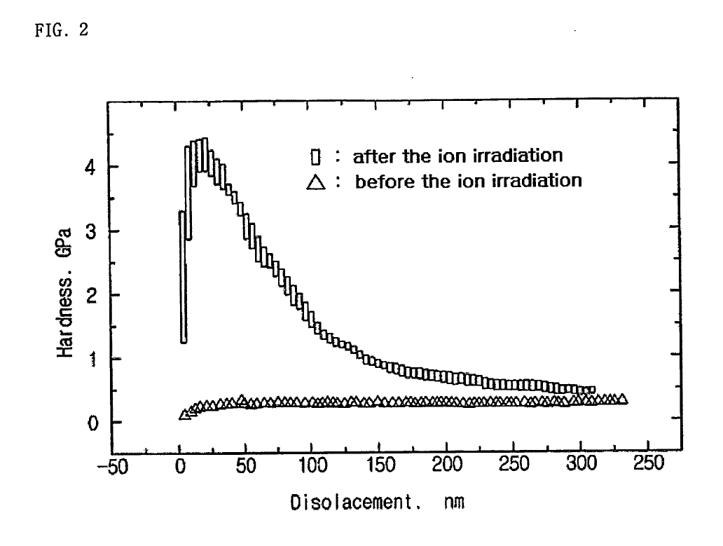

As for physical properties of the portable electronic terminal ionized at the surface thereof, surface hardness was 0.4 GPA at a depth of about 1.5 μm from the surface of the portable electronic terminal before the ion irradiation to the portable electronic terminal, but was increased by ten times to 4.4 GPA after the ion irradiation. The results were illustrated in FIG. 2.

### EXAMPLE 2

The productivity of products, for example, portable electronic terminal depending on surface electric conductivity was observed.

When an ion beam current of 10 mA was irradiated to front and rear surfaces of the portable electronic terminal, it took 15 sec to ionize the one portable electronic terminal with the surface electric conductivity of 10⁶ Ω/cm².

Additionally, when surface electric conductivities of the portable electronic terminal were 10⁷ Ω/cm², 10⁸ Ω/cm², and 10⁹ Ω/cm², it took 8, 4, and 2.5 sec to ionize the one portable electronic terminal, respectively.

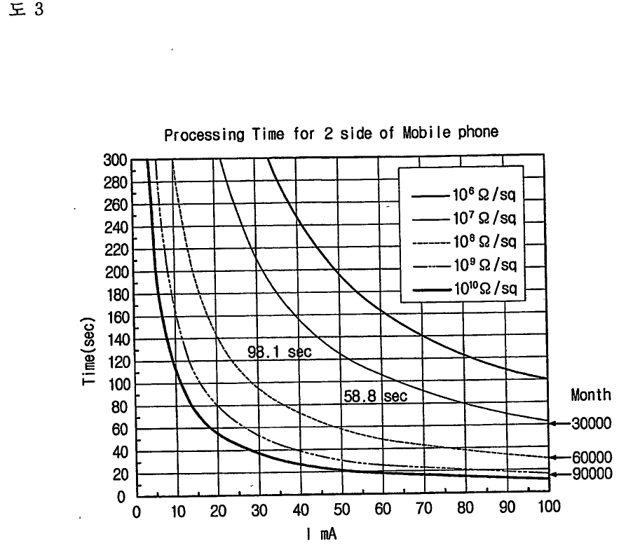

According to the present invention, as shown in FIG. 3, a defective proportion of the ionized portable electronic terminal is largely reduced, the ionization of the portable electronic terminal is automatically conducted with a low manpower without a danger, and productivity is improved. Therefore, hundreds of thousands portable electronic terminals per unit month are ionized using one unit ionization system according to the present invention.

### EXAMPLE 3

Electric and physical properties of polymer-molded goods depending on heat tolerances of polymer materials of the molded goods were observed.

ABS, PP, MPPO, MPES, MPSU, and ULTEM were used as a raw material of the polymer-molded goods. Of the various polymer materials, ABS or PP with the heat tolerance of 50 to 60° C. was used to effectively ionize the polymer-molded goods at an ion beam current of 20 mA or lower. Additionally, when the ion beam current was 50 mA, MPPO with the heat tolerance of 130° C. was most useful to ionize the polymer-molded goods, and when the ion beam current was 100 mA or lower, UPES, MPSU, and ULTEM with the heat tolerance of 150° C. or higher were useful to ionize the polymer-molded goods.

As for reuse of the used polymer-molded goods, when the ionization was conducted using 100% used polymer-molded goods, surface hardness and surface electric conductivity of the resulting polymer-molded goods were the same as the case of using only the fresh polymer-molded goods, but strength of the resulting polymer-molded goods was reduced in comparison with the case of using only the fresh polymer-molded goods. On the other hand, when 70% used polymer-molded goods and 30% fresh polymer-molded goods were mixed with each other and the resulting mixture was ionized according to the present invention, all the physical and electric properties of the resulting mixture were the same as the case of using only fresh polymer-molded goods. From the above description, it can be shown that reuse of the polymer-molded goods ionized at surfaces thereof according to the present invention is easier than that of the polymer-molded goods treated at the surfaces thereof according to a conventional process.

### INDUSTRIAL APPLICABILITY

As described above, the present invention provides a method of ionizing surfaces of polymer-molded goods, in which desired surface resistance is uniformly distributed on the surfaces of the polymer-molded goods. Therefore, electromagnetic waves radiated from electronic communication devices, such as portable electronic terminal, including the polymer-molded goods ionized at the surfaces thereof are effectively intercepted and the occurrence of static electricity on the surfaces of the electronic communication devices is prevented (that is to say, the surfaces of the electronic communication devices are shielded from being electrically charged), thereby inner circuits of the electronic communication devices are stably operated.

Higher interception of the electromagnetic waves radiated from the portable electronic terminal and the like are less harmful to humans by the electromagnetic waves. However, in consideration of the operation or performance of the portable electronic terminal, the interception of the electromagnetic waves negatively affects the interaction between parts constituting the portable electronic terminal. To avoid this disadvantage, it is necessary to isolate the parts from each other, but the isolation of the parts from each other contributes to increasing production costs of the portable electronic terminal. Hence, a preferable interception index is 20%, and is obtained when a surface electric conductivity of the portable electronic terminal is 10⁴ to 10⁵ Ω/cm². Thereby, it can be seen that the present invention is very useful to inexpensively manufacture end products while intercepting the electromagnetic waves and preventing surfaces of the end products from being electrically charged. Particularly, in the present invention, because the surface electric conductivity is uniform on the entire surfaces of the polymer-molded goods, the electromagnetic waves are effectively intercepted.

Further, the present invention is advantageous in that the polymer-molded goods are largely improved in terms of surface hardness, and the surfaces of the polymer-molded goods are finely deformed to minimize surface discoloration, defects, and abrasion of end products without a separate coating process.

Furthermore, the present invention provides a method of ionizing the surfaces of the polymer-molded goods so as to prevent the surfaces of various displays including CRT from being electrically charged and to intercept electromagnetic waves radiated through the surfaces of the displays, in which a resistance value against surface electric conductivity of each display is uniformly distributed on the entire surface of the display to protect a user's eyesight.

Other advantages of the present invention are that the polymer-molded goods have desired physical properties without a separate additive or filler, thereby reuse of the ionized polymer-molded goods is increased and pollution and a waste of resources are prevented.

As well, in the present invention, no high-priced additive is added to the polymer-molded goods and a complicated coating process are omitted. Accordingly, costs of the ionization of the polymer-molded goods are reduced and a defective proportion of the ionized polymer-molded goods is minimized, thereby contributing to improving workability.

Furthermore, helium gas is used as an ion source without using carbon, ceramics, and the like acting as a filler when a vessel to transport IC packages and LCDs is produced so as to ensure an optimum transport effect. In addition, costs of transport of the vessel are reduced because it is light, and uniform surface electric conductivity of 10⁸ to 10⁹ Ω/cm² is easily ensured. Moreover, production costs and raw material costs are reduced, a defective proportion is minimized, and reuse of the used polymer-molded goods is desirably increased, thereby excellent economic efficiency is secured.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. A method of ionizing surfaces of polymer-molded goods to intercept electromagnetic waves passing therethrough, comprising:
a first step of maintaining a main chamber and first and second pre-chambers located before and after the main chamber, which constitute a vacuum unit, under reduced pressure of 10⁵ torr using a vacuum pump;
a second step of holding objective products, to be irradiated by ions, by a spring holder positioned on a carrier of an inlet chamber, and transferring the objective products held in the spring holder through a preheating chamber and the first pre-chamber into the main chamber;
a third step of generating plasma by heating of a filament or arc generation of an ionization gun while controlling an ion beam current of electric power supplied to an ion generating gun in the main chamber to a predetermined level, adding helium gas, argon gas, or nitrogen gas into the plasma to yield gas cations, and irradiating the gas cations to the objective products; and
a fourth step of moving the resulting ionized products from the main chamber to the second pre-chamber using the carrier, and then discharging the resulting ionized products through an outlet chamber.

2. The method as set forth in claim 1, wherein the main chamber is under a nitrogen gas (N₂) atmosphere or an argon gas (Ar) atmosphere.

3. The method as set forth in claim 1, wherein the main chamber is under a helium gas (He) atmosphere.

4. The method as set forth in claim 1, wherein the ion beam current is controlled in conformity to heat tolerance of the objective products when an ion beam is irradiated to the objective products.

5. The method as set forth in claim 1, wherein an irradiation time of the ion beam current to the objective products is controlled so as to regulate surface electric conductivities of the objective products when an ion beam is irradiated to the objective products.

6. The method as set forth in claim 1, wherein an intensity of the ion beam current is controlled so as to regulate surface electric conductivities of the objective products when an ion beam is irradiated to the objective products.
